(19) United States
(12) Patent Application Publication
(10) Pub. No.: US 2012/0109756 A1
(43) Pub. Date: May 3, 2012

(54) ADVERTISING SERVICE CONTROL APPARATUS AND METHOD THEREOF

(75) Inventors: Eun-Joo KIM, Seoul (KR); Yool Kwon, Daejeon-si (KR); Young-Boo Kim, Gongju-si (KR)

(73) Assignee: Electronics and Telecommunications Research Institute, Daejeon (KR)

(21) Appl. No.: 13/287,688

(22) Filed: Nov. 2, 2011

(30) Foreign Application Priority Data
Nov. 3, 2010 (KR) 10-2010-0108842

(51) Int. Cl. G06Q 30/02

(52) U.S. Cl. 705/14.66; 705/14.4

(57) ABSTRACT

An advertising service control apparatus and method thereof. The advertising service control apparatus includes an intelligent switch to control packet data transmission/reception between a user terminal and a service server. The intelligent switch may be implemented to provide the user terminal with an advertisement which is found from the advertisement DB corresponding to advertising selection information. Accordingly, a network provider may obtain additional profit from advertising.

### CROSS-REFERENCE TO RELATED APPLICATION(S)

This application claims the benefit under 35 U.S.C. §119(a) of Korean Patent Application No. 10-2010-0108842, filed on Nov. 3, 2010, in the Korean Intellectual Property Office, the entire disclosure of which is incorporated herein by reference for all purposes.

### BACKGROUND

1. Field

The following description relates to an advertising technology, and more particularly, to an advertising service control apparatus and a method thereof.

2. Description of the Related Art

In conventional advertising on the Internet, advertisers pay service providers for advertising costs and in response to a service request from a user terminal, a service server offers advertisements along with the relevant service to the user terminal.

Since the service providers offer both the service and the advertisements, a network provider enables to make profit only from network usage fees (network connection fees), but cannot obtain additional profit from advertising.

### SUMMARY

The following description relates to an advertising control apparatus which allows a network provider, instead of a service provider, to offer advertisements and thus obtain additional profit from advertising.

In one general aspect, there is provided an advertising service control apparatus including: an advertisement database (DB) configured to store advertisements; and an intelligent switch configured to control packet data transmission/reception between a user terminal and a service server and to provide the user terminal with an advertisement which corresponds to advertising selection information and is found from the advertisement DB.

In another general aspect, there is provided an advertising service control method of an advertising service control apparatus which includes an advertisement managing unit and an intelligent switch, the method including: receiving, at the advertisement managing unit, an advertisement request corresponding to advertisement selection information from the intelligent switch; the advertisement managing unit searching for the advertisement corresponding to the advertisement selection information from an advertisement database (DB); transmitting the found advertisement from the advertisement managing unit to the intelligent switch; and the advertisement managing unit providing a user terminal with the advertisement corresponding to the advertisement selection information.

Other features and aspects may be apparent from the following detailed description, the drawings, and the claims.

### BRIEF DESCRIPTION OF THE DRAWINGS

FIG. 1 is a diagram illustrating an example of Internet advertising.

FIG. 2 is a diagram illustrating an example of an advertising service control apparatus.

FIG. 3 is a diagram illustrating an example of an advertising service control apparatus that provides an advertisement in real time.

FIG. 4 is a diagram illustrating another example of the advertising service control apparatus that provides an advertisement in non-real time.

FIG. 5 is a diagram illustrating another example of an advertising service control apparatus that provides an advertisement based on user preference information.

FIG. 6 is a diagram illustrating another example of the advertising service control apparatus that provide an advertisement based on subscriber information.

FIG. 7 is a diagram illustrating another example of the advertising service control apparatus that provides an advertisement based on policy information.

FIG. 8 is a flowchart illustrating an example of an advertising service control method of an advertising service control apparatus.

Throughout the drawings and the detailed description, unless otherwise described, the same drawing reference numerals will be understood to refer to the same elements, features, and is structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

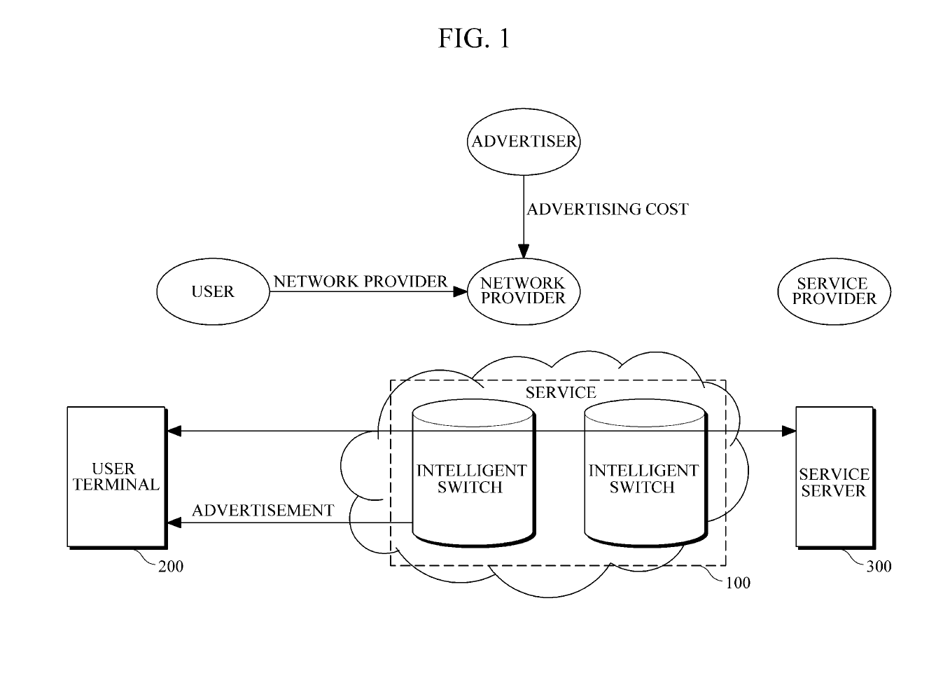

FIG. 1 illustrates a diagram of an example of Internet advertising. As shown in FIG. 1, Internet advertisement is provided by a network provider, unlike conventional Internet advertisement that is provided by a service provider.

When an advertiser pays the network provider for advertising cost and a user terminal 200 issues a service request to a service server 300, or regardless of the service request from the user terminal 200, an advertising service control apparatus 100 in a network provider side periodically or non-periodically provides advertisement to the user terminal 200, and thus the network provider obtains additional profit from the advertisement.

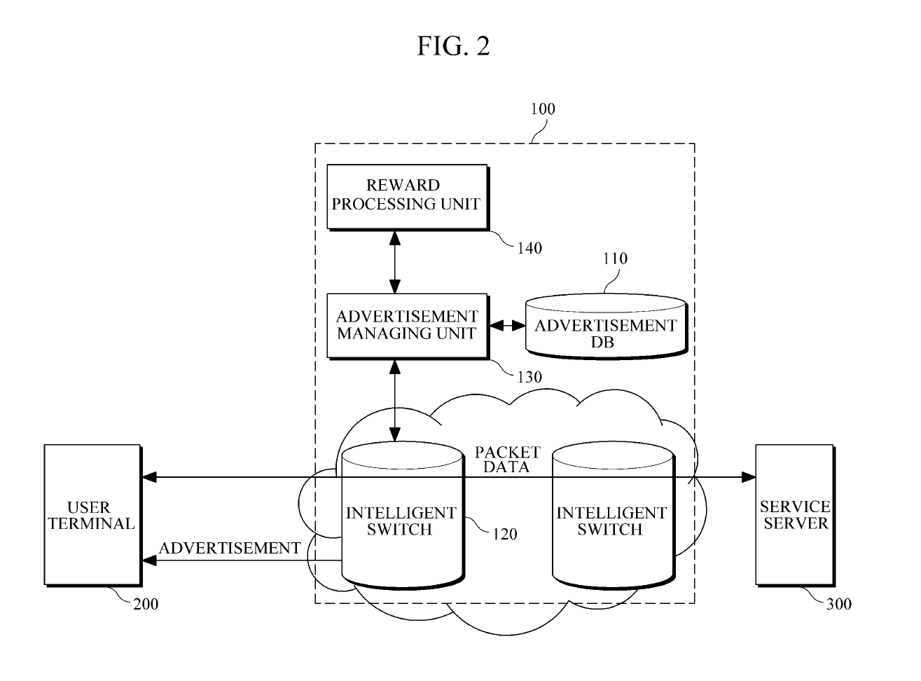

FIG. 2 illustrates a diagram of an example of an advertising service control apparatus. As shown in FIG. 2, the advertising service control apparatus 100 may include an advertisement database (DB) 110 and an intelligent switch 120.

The advertisement DB 110 may store advertisements. More specifically, the advertisement DB 110 may store advertisement data which have been provided by advertisers and are mapped to advertising selection information, and the advertisement data may be image or video data.

The intelligent switch 120 may control packet data transmission and/or reception between a user terminal 200 and a service server 300, and may provide the user terminal 120 with an advertisement which corresponds to advertising selection information and is found in the advertisement DB 110.

In this case, the advertising selection information may be subscriber information that includes at least one of user preference information, sex, age, and location information, or policy information for advertising transmission control.

Thus, the intelligent switch 120 may provide an advertisement to the user terminal 200 based on the user preference information, subscriber information, or policy information.

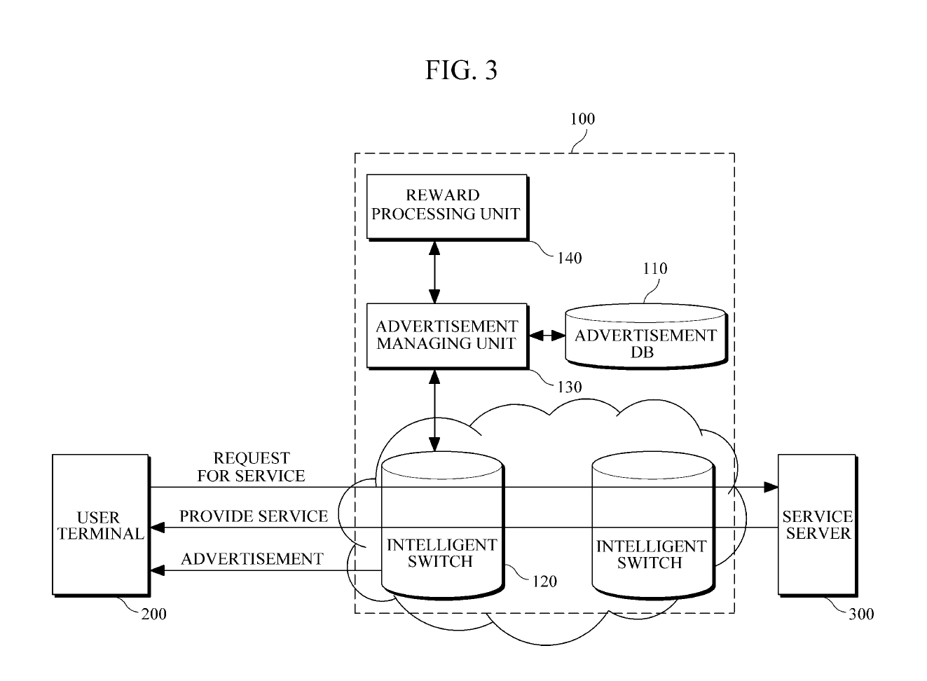

As shown in FIG. 3, the user terminal 200 issues a service request to the service server 300, the intelligent switch 120 may provide an advertisement corresponding to the advertising selection information to the user terminal 200 in real time. FIG. 3 illustrates a diagram of an example of an advertising service control apparatus that provides an advertisement in real time.

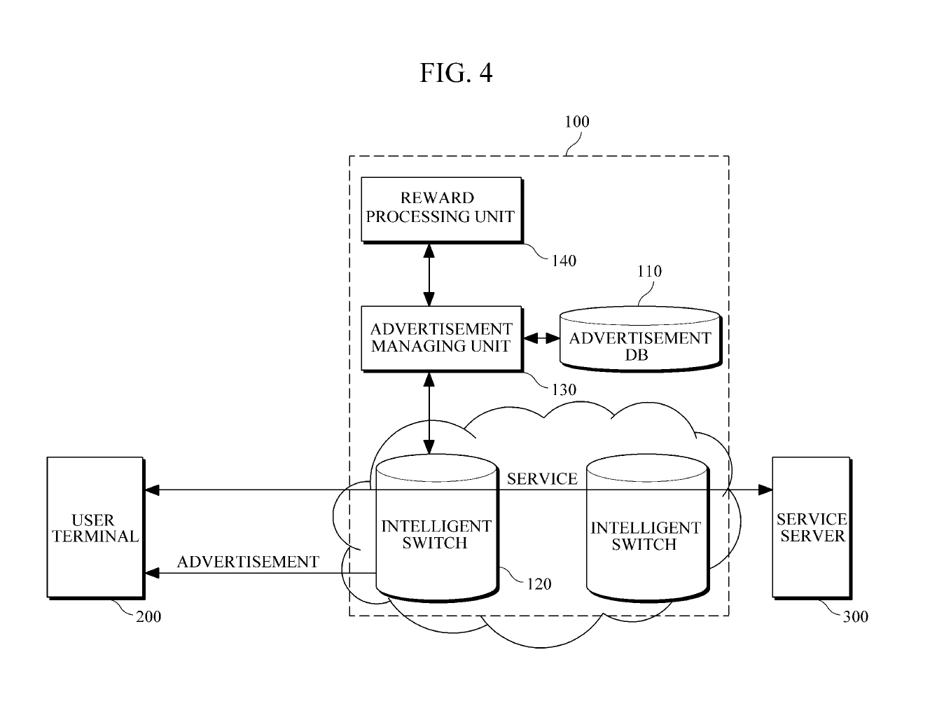

Unlike the example shown in FIG. 3, the intelligent switch 120 may provide an advertisement to a user terminal 200 corresponding to the advertising selection information periodically or non-periodically, as shown in an example illustrated in FIG. 4, regardless of the service request from the user terminal 200 to the service server 300. FIG. 4 illustrates a diagram of another example of the advertising service control apparatus that provides an advertisement in non-real time.

Alternatively, the user terminal 200 is associated with the intelligent switch 120 and installs an advertising agent (not illustrated) that reproduces the advertisement provided by the intelligent switch 120. The advertising agent executes an advertisement corresponding to the advertising selection information, thereby allowing the user to view the advertisement.

Accordingly, the advertisement is provided through the intelligent switch 120 in a network provider instead of the service server 300 in a service provider, and thus the network provider may obtain additional profit from advertising.

The intelligent switch 120 may use two types of methods of obtaining an advertisement corresponding to the advertising selection information from the advertisement DB 110. As a first method, the intelligent switch 120 may directly search for the advertisement corresponding to the advertising selection information from the advertisement DB 110.

However, because the intelligent switch 120 primarily controls packet data transmission/reception between the user terminal 200 and the service server 300, load may occur in packet data transmission/reception due to the advertisement DB search by the intelligent switch 120.

As a second method, an agent may be provided between the intelligent switch 120 and the advertisement DB 110 to search for the advertisement corresponding to the advertising selection information from the advertisement DB 110 instead of the intelligent switch 120 searching for the advertisement from the advertisement DB 110.

The second method affects the packet data transmission/reception of the intelligent switch 120 less compared to the first method. In the second method, an advertisement managing unit 130 may be installed between the intelligent switch 120 and the advertisement DB 110 to act as an agent for searching for an advertisement corresponding to advertising selection information.

The advertisement managing unit 130 may manage advertisements stored in the advertisement DB 110, and may search for an advertisement corresponding to advertising selection information from the advertisement DB 110 in response to a request for the advertisement from the intelligent switch 120 and transmit the found advertisement to the intelligent switch 120.

That is, the advertisement managing unit 130 may map an advertisement provided by an advertiser to advertising selection information according to manipulation of an operator, and store and register the mapped advertisement in the advertisement DB 110 or delete an advertisement from the advertisement DB 110.

In addition, the advertisement managing unit 130 may search for an advertisement corresponding to advertising selection information from the advertisement DB 110 in response to a request for the advertisement from the intelligent switch 120, and transmit the found advertisement to the intelligent switch 120.

As described above, the advertisement managing unit 130 acts as an agent between the intelligent switch 120 and the advertisement DB 110 to search for an advertisement corresponding to advertising selection information, and hence the advertisement corresponding to the advertising selection information is enabled to be found with a very small effect on packet data transmission/reception process of the intelligent switch 120.

In another example, the advertising service control apparatus 100 may further include a reward processing unit 140. The reward processing unit 140 may accumulate a predefined cost for an advertisement that a user of the user terminal 200 views from among provided advertisements, and may regularly subtract the accumulated cost from a network usage fee to reward for viewing the advertisement.

Accordingly, since, for example, a reduction in the network usage fee may be offered to the user as a reward for viewing the advertisement, viewing advertisement may be beneficial for the user to reduce the network usage fee.

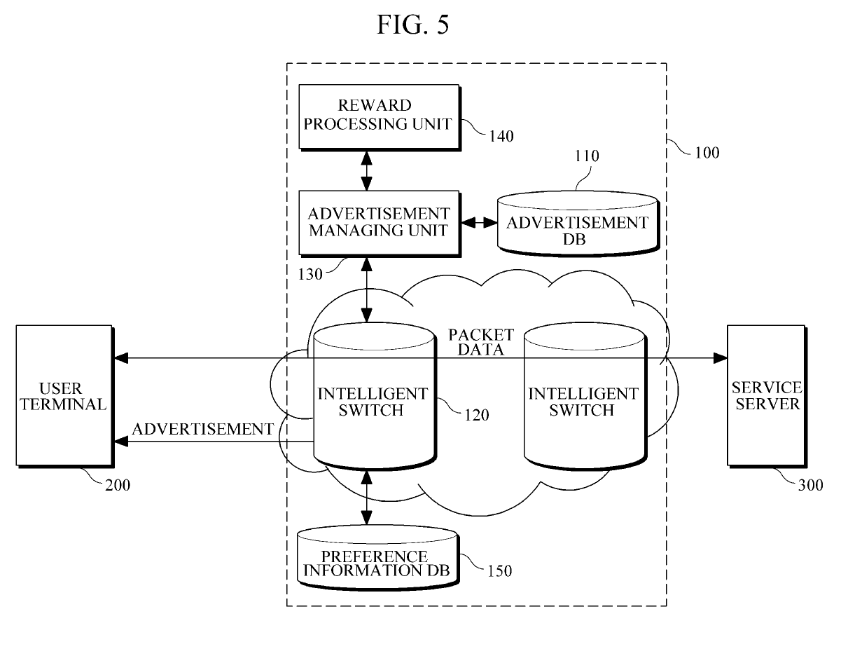

FIG. 5 illustrates a diagram of another example of an advertising service control apparatus that provides an advertisement based on user preference information.

If the advertising selection information is user preference information, as shown in the example illustrated in FIG. 5, the advertising service control apparatus 100 may further include a user preference information DB 150.

The user preference information DB 150 may store user preference information. In this case, an intelligent switch 120 may analyze packet data and accumulate frequently used keywords to collect the user preference information.

For example, the intelligent switch 120 may perform stateful packet inspection (SPI) to analyze a header of packet data, and read a destination address and a service type of the packet data. Thus, continuous SPI on packet data may assist in collecting an IP address or a service which is preferred by a user.

In another example, the intelligent switch 120 may perform deep packet inspection (DPI) to analyze a payload of packet data, and analyze service features or diverse protocols supported by an upper application layer and read content signature recognition. Accordingly, continuous DPI on packet data may assist in collecting characteristics of the service preferred by the user.

The intelligent switch 120 may search for user preference information from the user preference information DB 150 to obtain advertising selection information. In response to a request for an advertisement corresponding to the user preference information obtained by the intelligent switch 120, an advertisement managing unit 130 may search for the advertisement corresponding to the user preference information from the advertisement DB 110 and transmit the found advertisement to the intelligent switch 120.

The intelligent switch 120 may provide the advertisement transmitted from the advertisement managing unit 130 to the user terminal 200. Thus, advertising based on the user preference information is achieved.

For example, if it is found through the continuous packet data analysis of the intelligent switch 120 that a website frequently visited by the user is related to cosmetics, ‘cosmetics’ may be stored as user preference information in the user preference information DB 150, and the intelligent switch 120 may receive advertisements corresponding to ‘cosmetics’ and provide them to the user terminal 200, thereby allowing the user to view advertisements related to preferred ‘cosmetics.’

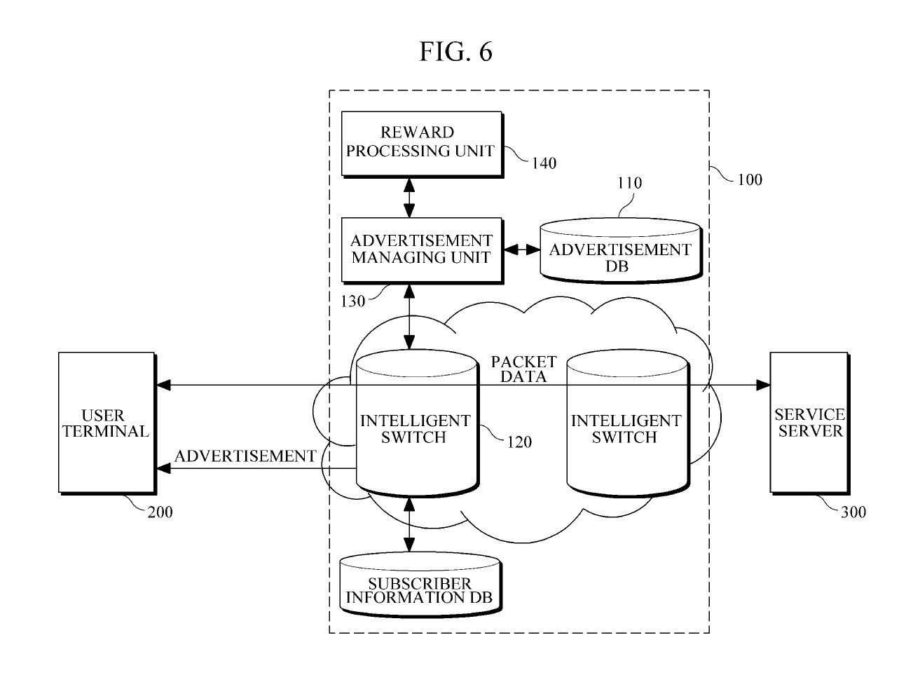

FIG. 6 illustrates a diagram of another example of the advertising service control apparatus that provide an advertisement based on subscriber information.

If advertising selection information is subscriber information that includes at least one of sex, age, and location information, the advertising service control apparatus 100 may further include a subscriber information DB 160 as shown in FIG. 6.

The subscriber information DB 160 may store subscriber information that includes at least one of sex, age, and location information. In this case, the subscriber information may be input when a user subscribes to a service for use of a network.

For example, the intelligent switch 120 may search for subscriber information from the subscriber information DB 160 to obtain advertising selection information. In response to a request for an advertisement corresponding to the subscriber information obtained by the intelligent switch 120, an advertisement managing unit 130 may search for the advertisement corresponding to the subscriber information from the advertisement DB 110 and transmit the found advertisement to the intelligent switch 120.

Then, the intelligent switch 120 may transmit the advertisement received from the advertisement managing unit 130 to the user terminal 200, and thus advertising based on the subscribe information may be achieved.

For example, if subscriber information of a female subscriber who is 23-year old and resides in a metropolis is stored in the subscriber information DB 160, the intelligent switch 120 may receive advertisements corresponding to ‘fashion’ that interests metropolitan women in their 20s from the advertisement managing unit 130, and provide the found advertisements to the user terminal 200, thereby allowing the subscriber to view the ‘fashion’ related advertisements.

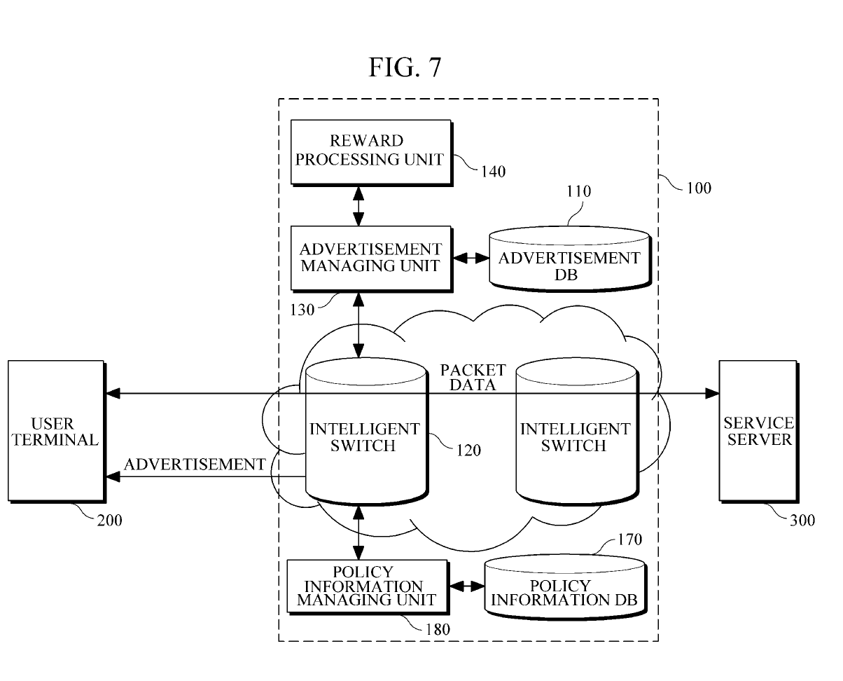

FIG. 7 illustrates a diagram of another example of the advertising service control apparatus that provides an advertisement based on policy information.

If advertising selection information is policy information for advertising transmission control, the advertising service control apparatus 100 may further include a policy information DB 170 as shown in the example illustrated in FIG. 7.

The policy information DB 170 may store policy information for advertising transmission control. For example, the policy information may include a variety of information involved with advertising transmission control, such as advertising interval, advertising transmission time slot, and the number of advertisement transmissions.

The advertising service control apparatus 100 may further include a policy information managing unit 180. The policy information managing unit 180 may receive policy information and store it in the policy information DB 170, and provide the policy information to the intelligent switch 120.

The intelligent switch 120 may control a transmission interval, transmission time slot, or the number of transmissions of an advertisement to be transmitted to the user terminal 200 according to the policy information provided by the policy information managing unit 180.

The policy information based advertisement may be provided in combination with the advertisement based on the user preference information as shown in FIG. 5 or the advertisement based on the subscriber information as shown in FIG. 6.

Accordingly, the intelligent switch 120 may provide a user preference based advertisement or a subscriber information based advertisement to the user terminal 200 according to the policy information, and thus user-tailored advertisement can be achieved.

As described above, an intelligent switch in a network provider side provides advertisements instead a service server in a service provider side, and hence the network provide can obtain additional profit from advertising and a user may have a network usage fee reduced as a reward for viewing the advertisement.

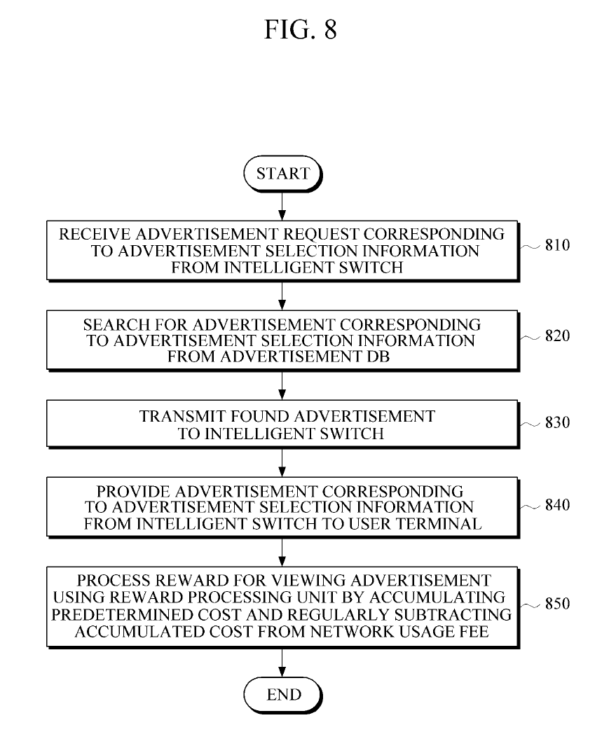

FIG. 8 is a flowchart illustrating an example of an advertising service control method of an advertising service control apparatus. As shown in FIG. 8, in response to an intelligent switch of an advertising service control apparatus issuing a service request corresponding to advertisement selection information, an advertisement managing unit receives the service request from the intelligent switch in operation 810.

The advertisement managing unit searches an advertisement DB for an advertisement corresponding to the advertisement selection information in operation 820, and transmits the found advertisement to the intelligent switch in operation 830.

In response to the reception of the advertisement, the intelligent switch provides a user terminal with the advertisement which corresponds to the advertisement selection information. Accordingly, an advertisement is provided not by a service provider, but by a network provider that operates the intelligent switch, and thus the network provider can obtain additional profit from advertising.

In another aspect, the advertising service control apparatus uses a reward processing unit when providing the advertisement to the user terminal. In operation 850, the reward processing unit rewards a user for viewing the advertisement by accumulating a predefined cost for viewing the advertisement provided to the user terminal and regularly subtracting the accumulated cost from a network usage fee of the user.

Consequently, the user may be rewarded from watching the advertisement by obtaining a discount for a network usage fee.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An advertising service control apparatus comprising:
an advertisement database (DB) configured to store advertisements; and
an intelligent switch configured to control packet data transmission/reception between a user terminal and a service server and to provide the user terminal with an advertisement which corresponds to advertising selection information and is found from the advertisement DB.

2. The advertising service control apparatus of claim 1, further comprising:
an advertisement managing unit configured to manage the advertisements stored in the advertisement DB, to search for the advertisement corresponding to the advertising selection information from the advertisement DB and to provide the found advertisement to the intelligent switch.

3. The advertising service control apparatus of claim 1, wherein the advertising selection information is user preference information.

4. The advertising service control apparatus of claim 1, wherein the advertising selection information is subscriber information that includes at least one of sex, age, and location information of a subscriber.

5. The advertising service control apparatus of claim 1, wherein the advertising selection information is policy information for advertising transmission control.

6. The advertising service control apparatus of claim 3, further comprising:
a user preference information DB configured to store user preference information.

7. The advertising service control apparatus of claim 6, wherein the user preference information is collected by the intelligent switch that analyzes packet data and accumulates frequently used keywords.

8. The advertising service control apparatus of claim 5, wherein the intelligent switch is further configured to search for user preference information from the user preference information DB to obtain advertising selection information.

9. The advertising service control apparatus of claim 4, further comprising:
a subscriber information DB configured to store subscriber information that includes at least one of sex, age and location information of a subscriber.

10. The advertising service control apparatus of claim 9, wherein the subscriber information is input at the time of subscribing to a service for use of a network.

11. The advertising service control apparatus of claim 9, wherein the intelligent switch is further configured to search for subscriber information from the subscriber information DB to obtain advertising selection information.

12. The advertising service control apparatus of claim 5, further comprising:
a policy information DB configured to store policy information for advertising transmission control.

13. The advertising service control apparatus of claim 12, wherein the policy information includes an advertising transmission interval, an advertising transmission time slot, or the number of advertising transmissions.

14. The advertising service control apparatus of claim 12, further comprising:
a policy information managing unit configured to store established policy information in the policy information DB and to provide the policy information to the intelligent switch.

15. The advertising service control apparatus of claim 1, wherein the intelligent switch is further configured to provide an advertisement corresponding to advertising selection information to the user terminal in real time when the user terminal issues a request for a service to the service server.

16. The advertising service control apparatus of claim 1, wherein the intelligent switch is further configured to periodically or non-periodically provide an advertisement corresponding to advertising selection information to the user terminal in non-real time.

17. The advertising service control apparatus of claim 1, further comprising:
a reward processing unit configured to reward a user for viewing an advertisement by accumulating a predefined cost for viewing the advertisement provided to the user terminal and regularly subtracting the accumulated cost from a network usage fee of the user.

18. The advertising service control apparatus of claim 1, wherein the user terminal has an advertising agent mounted thereon which is associated with the intelligent switch and reproduces an advertisement provided by the intelligent switch.

19. An advertising service control method of an advertising service control apparatus which includes an advertisement managing unit and an intelligent switch, the method comprising:
receiving, at the advertisement managing unit, an advertisement request corresponding to advertisement selection information from the intelligent switch;
the advertisement managing unit searching for the advertisement corresponding to the advertisement selection information from an advertisement database (DB);
transmitting the found advertisement from the advertisement managing unit to the intelligent switch; and
the advertisement managing unit providing a user terminal with the advertisement corresponding to the advertisement selection information.

20. The advertising service control method of claim 19, further comprising:
when providing the advertisement to the user terminal, processing a reward for viewing the advertisement using a reward processing unit of the advertising service control apparatus by accumulating a predefined cost for viewing the advertisement provided to the user terminal and regularly subtracting the accumulated cost from a network usage fee of the user.
